(19) United States
(12) Patent Application Publication
(10) Pub. No.: US 2020/0301128 A1
(43) Pub. Date: Sep. 24, 2020

(54) Moving Object Imaging Device and Moving Object Imaging Method

(71) Applicant: HITACHI, LTD., Tokyo (JP)

(72) Inventors: Daisuke MATSUKA, Tokyo (JP); Masahiro MIMURA, Tokyo (JP); Kazuhiko HINO, Tokyo (JP); Takayuki FUJIMURA, Tokyo (JP)

(73) Assignee: Hitachi, Ltd., Tokyo (JP)

(21) Appl. No.: 16/088,165

(22) PCT Filed: Feb. 2, 2018
(86) PCT No.: PCT/JP2018/003574

§ 371 Date: Sep. 25, 2018

(30) Foreign Application Priority Data
Sep. 22, 2017 (JP) 2017-182237

(51) Int. Cl. G02B 26/08; H04N 5/232; G03B 17/17

(52) U.S. Cl. CPC G02B 26/0816; G03B 17/17; H04N 5/232

(57) ABSTRACT

A moving object imaging device is provided in which an optical axis of a camera is changed by a plurality of movable mirrors having different sizes, and which not only improves image quality but also maintains tracking performance. The invention is directed to a moving object imaging device for tracking and imaging a moving object crossing an approximately horizontal direction, including: a camera configured to capture an image of the moving object sequentially reflected by a plurality of movable mirrors; a mirror movable in a gravity direction configured to define a gravity direction of the captured image of the camera as a scanning direction; a first motor configured to change an angle of the mirror movable in the gravity direction; a mirror movable in a left-and-right direction configured to define a left-and-right direction of the captured image of the camera as a scanning direction; a second motor configured to change an angle of the mirror movable in the left-and-right direction; and a controller configured to control the camera, the first motor, and the second motor, the camera capturing the image of the moving object that is sequentially reflected by the mirror movable in the gravity direction and the mirror movable in the left-and-right direction.

### TECHNICAL FIELD

The present invention relates to a moving object imaging device and a moving object imaging method, and more particularly, to a moving object imaging device and a moving object imaging method for imaging a flying object such as a multi-copter, and the like freely moving in space, and a traveling object such as a vehicle, and the like traveling on a road.

### BACKGROUND ART

In a related art, a device for imaging a moving object such as a flying object, and the like moving in a target area has been known. In order to track and image the moving object in motion, it is required to control an optical axis of a camera so as to capture the moving object in an imaging range of the camera. As a control method for directing the optical axis of the camera toward the moving object, known is a method in which the optical axis of the camera tracks the moving object by driving a plurality of rotatably movable mirrors by using motors of respectively different rotary shafts. For example, this technology is disclosed in JP-A-10-136234 (PTL 1), and in the abstract of JP-A-10-136234 (PTL 1), the technology is described as follows: a light transmissive window W1 is provided in a light-impermeable casing B1, and an imaging device C1, an azimuth angle rotary reflection mirror M1, a tilt angle rotary reflection mirror M2, and motors m1 and m2 for rotating the mirrors M1 and M2 are disposed in the casing B1. After passing through the window W1, a light beam I from an object visual field is regularly reflected by the mirror M1 and is further reflected by the mirror M2, whereby an object image returns to an erect image and the erect image of the object is incident on the imaging device C1.

### CITATION LIST

### Patent Literature

PTL 1: JP-A-10-136234

### SUMMARY OF INVENTION

### Technical Problem

The performance required for the moving object imaging device is to acquire a clearer image. It is effective to increase the number of pixels of the camera to improve image quality. For example, when imaging is performed at 12K resolution (horizontal 1920 pixels×vertical 1080 pixels) and 4K resolution (horizontal 3840 pixels×vertical 2160 pixels), since the resolution in the vertical and horizontal directions is respectively improved by two times at the 4K resolution with respect to the 2K resolution, the same subject can be imaged with four times the number of pixels of the 2K resolution at the 4K resolution.

Here, when both sizes of one pixel of imaging elements of the 4K resolution and the 2K resolution are 10 μm, a size of the imaging element for the 2K resolution is 19.2 mm in height×10.8 mm in width, and the imaging element becomes two times larger by 38.4 mm in height×21.6 mm in width at the 4K resolution. Therefore, the angles of view become equalized by doubling a focal length of a lens mounted on the camera, thereby suppressing occurrence of vignetting.

However, when the focal length is set to be doubled while maintaining an aperture diameter of the lens, an F value indicating a degree of taking in the light by the camera becomes quadrupled, and brightness of an obtained image becomes ¼. Further, the depth of field also becomes shallow, and for example, when tracking and imaging a moving object moving at a high speed in a depth direction, the focus becomes easy to be unsharp. Further, brightness is alleviated by extending exposure time, however, extending the exposure time causes motion blur (blur) in the case of the moving object moving at a high speed. Due to the aforementioned causes, when realizing image improvement by increasing the number of pixels, since it is required to increase the aperture diameter of the lens, as disclosed in JP-A-10-136234 (PTL 1), it is required to enlarge a reflection area of a movable mirror in the moving object imaging device which images the moving object via the movable mirror.

However, enlargement of the movable mirror leads to an increase in load mass of a motor, such that a larger motor is required to obtain the same response performance. The large motor is required to flow more current, such that a temperature of the motor rises due to copper loss generated by a coil. Since the temperature rise of the motor leads to deterioration in torque generated by the motor, a thermal deformation of peripheral optical components, and the like, a device for actively cooling the motor is newly required, whereby the device becomes enlarged and complicated. The moving object imaging device is frequently used as a monitoring device, such that the enlargement and complexity of the device are not desirable.

The present invention has been made in an effort not only to solve the above-mentioned problems, but also to provide a moving object imaging device, in which an optical axis of a camera is changed by a plurality of movable mirrors having different sizes, that not only improves image quality but also maintains tracking performance while suppressing a heat generation amount of a motor driving the movable mirrors

### Solution to Problem

In order to solve the above-mentioned problems, a moving object imaging device according to the present invention for tracking and imaging a moving object crossing an approximately horizontal direction may include a camera configured to capture an image of the moving object sequentially reflected by a plurality of movable mirrors; a mirror movable in a gravity direction configured to define a gravity direction of the captured image of the camera as a scanning direction; a first motor configured to change an angle of the mirror movable in the gravity direction; a mirror movable in a left-and-right direction configured to define a left-and-right direction of the captured image of the camera as a scanning direction; a second motor configured to change an angle of the mirror movable in the left-and-right direction; and a controller configured to control the camera, the first motor, and the second motor, wherein the camera captures the image of the moving object that is sequentially reflected by the mirror movable in the gravity direction and the mirror movable in the left-and-right direction.

Further, the moving object imaging device for tracking and imaging a moving object approaching from an approximately horizontal direction may include a camera configured to capture an image of the moving object sequentially reflected by a plurality of movable mirrors; a mirror movable in a gravity direction configured to define a gravity direction of the captured image of the camera as a scanning direction; a first motor configured to change an angle of the mirror movable in the gravity direction; a mirror movable in a left-and-right direction configured to define a left-and-right direction of the captured image of the camera as a scanning direction; a second motor configured to change an angle of the mirror movable in the left-and-right direction; and a controller configured to control the camera, the first motor, and the second motor, wherein the camera captures the image of the moving object that is sequentially reflected by the mirror movable in the gravity direction and the mirror movable in the left-and-right direction.

### ADVANTAGEOUS EFFECTS OF INVENTION

According to a moving object imaging device and a moving object imaging method, since a heat generation amount of a motor can be reduced even though a large movable mirror is used to improve image quality, it is possible not only to improve the image quality but also to maintain tracking performance.

### BRIEF DESCRIPTION OF DRAWINGS

FIG. 1 is a block diagram of a moving object imaging device 1 and a flying object 2a in a first embodiment.

FIG. 2 is a top plan view of movable mirrors 12a and 12b in the first embodiment.

FIG. 3 is a cross-sectional diagram of a moving object imaging device when a direction of a movable mirror 12a is viewed from a camera mounting position in the moving object imaging device of the first embodiment.

FIG. 4 is a flow chart of processing which is executed by the moving object imaging device of the first embodiment.

FIG. 5 is a functional block diagram of a controller 14 in the first embodiment.

FIG. 6 illustrates a captured image which is processed to a gray scale by an image processing part 27 in the first embodiment.

FIG. 7A is a diagram illustrating a current flowing through a motor 13 in the first embodiment.

FIG. 7B is a diagram illustrating a current flowing through a motor 13b in the first embodiment.

FIG. 8A is a diagram when the moving object imaging device 1 and the flying object 2a in the first embodiment are viewed from the sky above.

FIG. 8B is a diagram when the moving object imaging device 1 and the flying object 2a in the first embodiment are viewed from a lateral direction.

FIG. 9A is a diagram illustrating a maximum angular speed of a motor 13a of the moving object imaging device 1 when each flight is performed in the first embodiment.

FIG. 9B is a diagram illustrating a maximum angular speed of a motor 13ba of the moving object imaging device 1 when each flight is performed in the first embodiment.

FIG. 10 is a block diagram of the moving object imaging device 1 and a traveling object 2b in a second embodiment.

FIG. 11A is a diagram when the moving object imaging device 1 and the traveling object 2b in the second embodiment are viewed from the sky above.

FIG. 11B is a diagram when the moving object imaging device 1 and the traveling object 2b in the second embodiment are viewed from a lateral direction.

FIG. 12A is a diagram illustrating a maximum angular speed of a motor 13a of the moving object imaging device 1 when each flight is performed in the second embodiment.

FIG. 12B is a diagram illustrating a maximum angular speed of a motor 13b of the moving object imaging device 1 when each flight is performed in the second embodiment.

FIG. 13 is a cross-sectional diagram of a moving object imaging device 1 when a direction of a movable mirror 12a is viewed from a camera mounting position in the moving object imaging device of a third embodiment.

### DESCRIPTION OF EMBODIMENTS

Hereinafter, each embodiment of the present invention will be described with reference to the drawings. Further, the present invention will be hereinafter described by being divided into a plurality of embodiments for convenience. Unless otherwise specified, the plurality of embodiments are not unrelated to each other, and one embodiment has a relationship with a part or whole parts of the other embodiment with respect to modifications, details, supplementary descriptions, and the like. Further, in all of the drawings for describing the following embodiments, those having the same functions will be denoted by the same reference sings in principle, and any redundant descriptions will omitted.

### First Embodiment FIRST EMBODIMENT

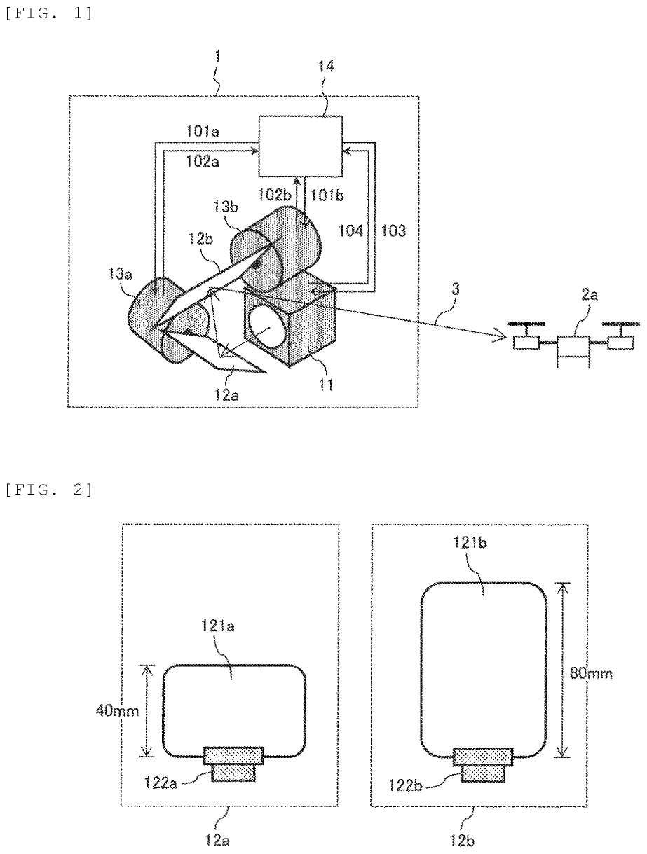

Described herein are a moving object imaging device 1 according to a first embodiment of the present invention that tracks and images a flying object crossing an approximately horizontal direction, and a moving object imaging method used for the same with reference to FIGS. 1 to 9B.

FIG. 1 is a block diagram including a moving object imaging device 1 of an embodiment and a flying object 2a which is a moving object. The flying object 2a shown in FIG. 1 is a flying object (quadcopter), which is viewed from a side-surface side, and which has four propellers and is capable of freely performing a horizontal movement, a direction change, and ascent and descent by changing the number of rotation of each propeller.

The moving object imaging device 1 is mainly aimed at tracking and imaging the flying object 2a crossing the approximately horizontal direction, and is provided with a camera 11, two movable mirrors 12a and 12b having different sizes, motors 13a and 13b for changing angles of the respective movable mirrors, and a controller 14 for controlling the camera 11 and the motors 13a and 13b. Here, the meaning of “crossing the approximately horizontal direction” is a motion including a lateral movement on a captured image 107 of the camera 11, and may include a relatively small longitudinal movement.

The movable mirror 12a is a mirror movable in a left-and-right direction in which a left-and-right direction of the captured image 107 of the camera 11 is defined as a scanning direction. The movable mirror 12b is a mirror movable in a gravity direction in which a gravity direction of the captured image 107 of the camera 11 is defined as a scanning direction. Further, it is characterized in that the camera 11 captures an image of the flying object 2a sequentially reflected by the movable mirror 12a and the movable mirror 12b, and the scanning direction of the movable mirror 12b positioned farthest from the camera 11 is the gravity direction. Further, it is characterized in that a reflection surface of the movable mirror 12b, a scanning direction of which is the gravity direction, is mounted so as to face a ground surface. The motors 13a and 13b have angle detectors (not shown) for detecting a rotational angle, and output the detected rotational angles to the controller 14 as detection angles 102a and 102b. Further, a display device for showing the captured image 107 to an operator, a command input device 20 to which an operator inputs a command, and a storage device for recording the captured image, all of which are not illustrated in the drawings, are connected to the moving object imaging device 1.

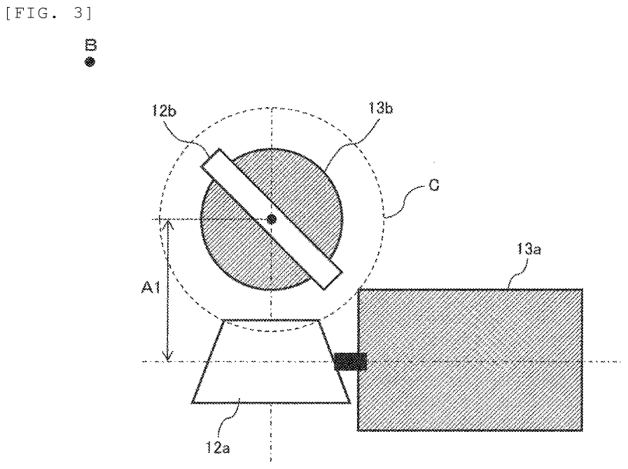

Here, a top plan view seen from the reflection surfaces of the movable mirrors 12a and 12b will be described with reference to FIG. 2. As shown here, the movable mirror 12a is provided with a reflection mirror part 121a and a mounting part 122a connecting the motor 13a and the reflection mirror part 121a. The movable mirror 12b is provided with a reflection mirror part 121b and a mounting part 122b connecting the motor 13b and the reflection mirror part 121b. In the embodiment, a length of the reflection mirror part 121a close to the camera 11 is set to 40 mm, and a length of the reflection mirror part 121b far from the camera 11 is set to 80 mm. Since the movable mirror 12b far from the camera 11 copes with a change of an optical axis in all of the movable areas of the movable mirror 12a close to the camera 11, the movable mirror 12b is set to be larger than the movable mirror 12a. As a movable area of the movable mirror 12a close to the camera 11 becomes larger, it is required to extend the movable mirror 12b far from the camera 11 in a rotational axis direction of the motor. According to the reasons described above, as a result of setting the sizes of both movable mirrors different, as shown in FIG. 2, moment of inertia when the small movable mirror 12a rotates around a motor shaft is 30.0 g·cm², and moment of inertia of the large movable mirror 12b is 45.0 g·cm².

FIG. 3 is a cross-sectional diagram of the moving object imaging device 1 when a direction of the movable mirror 12a is viewed from a mounting position of the camera 11. Here, a distance A1 between a rotary shaft of the motor 13a and a rotary shaft of the motor 13b is set to 42.5 mm, and a movable range of the movable mirror is set to ±20°. Further, a circle C indicates an area which is provided to prevent the movable mirror 12b with interfering with the motor 13a, and a fixed distance thereof is set around the rotary shaft of the movable mirror 12b.

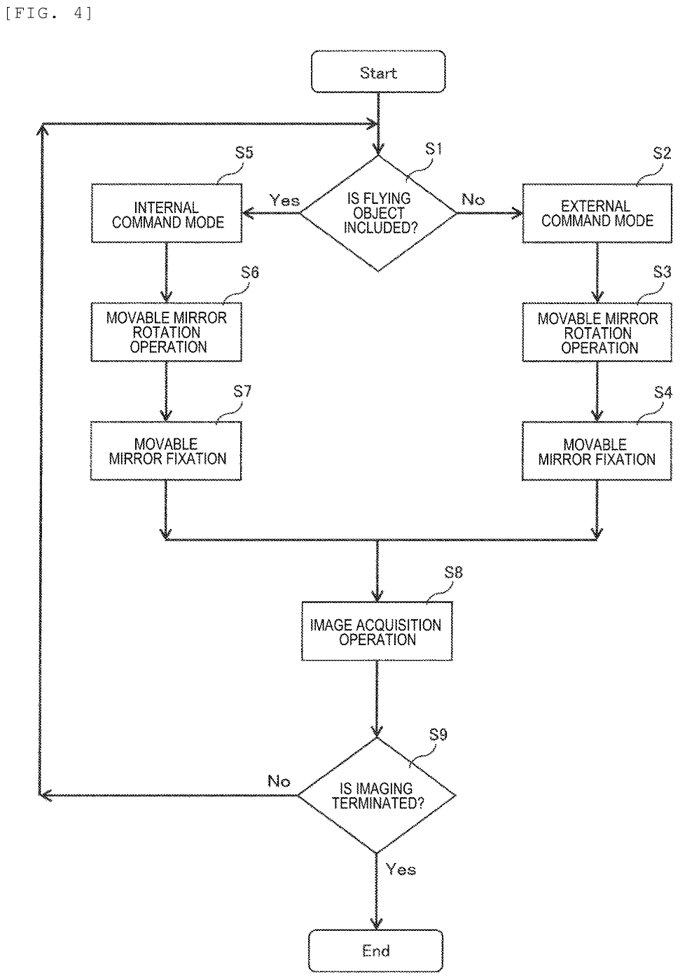

Next, imaging operation of the moving object imaging device according to the first embodiment will be described by using a flow chart shown in FIG. 4. The imaging operation of the moving object imaging device 1 is roughly classified into movable mirror rotation operation for driving the movable mirrors 13a and 13b to a target deflection angle; and image acquisition operation for acquiring the captured image 107 by starting exposure of the camera 11 in a state where an optical axis 3 is fixed, such that the movable mirror rotation operation and the image acquisition operation are alternately repeated in time series. In the embodiment, since the image is captured in a state where the movable mirror is fixed, a camera having a slow imaging period can be used, and further, there exists an advantage that an exposure time can be extended under an environmental condition where a quantity of light is insufficient, thereby coping with the environmental condition.

First, when starting the imaging operation, the controller 14 determines whether or not the flying object 2a which is a tracking target is included in the captured image 107 of the camera 11 at step S1. Next, when the flying object 2a is not included in the captured image 107, the controller 14 executes an external command mode at step S2, whereas when the flying object 2a is included in the captured image 107, an internal command mode is executed at step S5.

The external command mode at step S2 is a mode for an operator of the moving object imaging device 1 to operate the rotation of each movable mirror and to capture the flying object 2a of the tracking target in order for the flying object 2a thereof to be imaged by the camera 11. Further, the operator provides a target deflection angle command of each movable mirror to the controller 14 from the outside by using a command input device 20 such as a game pad, and the like while looking at the display device at step S3, and when the flying object 2a is captured, an angle of the movable mirror is fixed at step S4.

Meanwhile, the internal command mode at step S5 is a mode for the controller 14 to operate the rotation of each movable mirror and for tracking the flying object 2a of the tracking target in order for the camera 11 to image the flying object 2a thereof. Further, the target deflection angle command of each movable mirror is generated inside the controller 14 at step S6, and the movable mirror is fixed to the flying object 2a at a tracked angle at step S7.

At the step S3 or the step S6, the controller 14 adjusts and outputs an applied voltage so that driving currents 101a and 101b corresponding to a set target deflection angle flow through the respective motors 13a and 13b. As a result, the optical axis 3 of the camera 11 is controlled to face the flying object 2a. At the step S4 or the step S7, the completion of the movable mirror rotation operation at steps S3 and S6 by the detection angles 102a and 102b of the motors 13a and 13b is confirmed, the controller 14 outputs an imaging trigger signal 103 (refer to FIG. 1) to the camera 11, and the camera 11 starts exposure at step S8. When acquisition of the captured image 107 ends, the camera 11 outputs an imaging end signal 104 (refer to FIG. 1) to the controller 14, and the controller 14 confirms the presence or absence of an input of an imaging end command. When the imaging end command is not inputted, the controller 14 starts the next movable mirror rotation operation. The consecutively captured images 107 are acquired by repeating a series of above-mentioned operation, and when the imaging period is sufficiently short (for example, 30 images/sec which is the same as that of a general television), the images 107 acquired by the display device are consecutively displayed, thereby making it possible to provide a state of the flying object 2a crossing the approximately horizontal direction of the moving object imaging device 1 as a moving image.

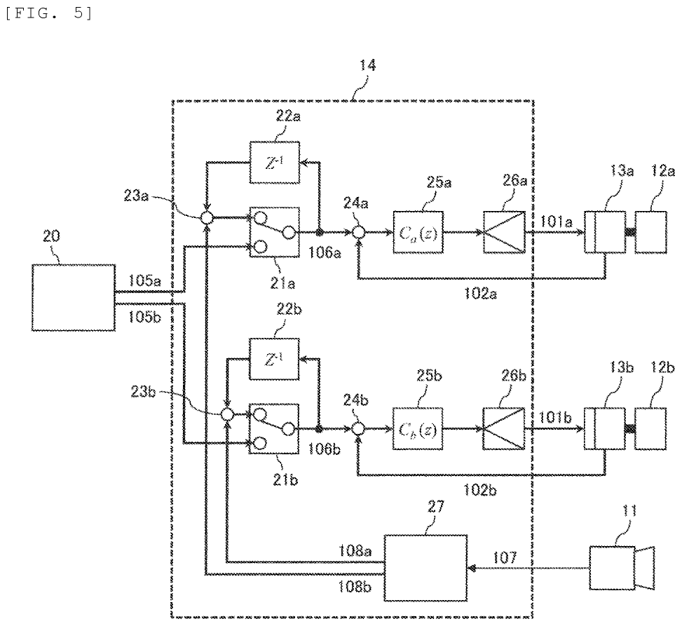

Next, details of the external command mode and the internal command mode will be described while referring to the functional block diagram of the controller 14 shown in FIG. 5.

As shown in FIG. 5, the command input device 20, the motors 13a and 13b, and the camera 11 are connected to the controller 14. Further, switches 21a and 21b, storage parts 22a and 22b, adders 23a, 23b, 24a, and 24b, compensators 25a and 25b, amplifiers 26a and 26b, and an image processing part 27 are provided inside the controller 14. Further, the controller 14 may be configured with hardware such as ASIC or FPGA, or may be configured with software that executes a program loaded into a memory by a CPU, or may be configured with a combination of the hardware and the software.

First, a method for controlling a deflection angle of the motor 13a in the external command mode will be described. Further, here, while the method for controlling the motor 13a is described, redundant descriptions of the motor 13b using the same control method will be omitted. In the external command mode, a changeover switch 21a is on the lower side, and a deviation angle between a target angle command 105a given from the external commend input device 20 and the detection angle 102a obtained by an angle detector of the motor 13a is added by the adder 24a by inverting the detection angle 102a positively and negatively. The compensator 25a adjusts a magnitude of the driving current 101a flowing through the amplifier 26a to the motor 13a so as to make the deviation zero. Further, the compensator 25a performs PID control.

Then, a method for controlling the deflection angle of the motor 13a in the internal command mode will be described. In the internal command mode, the changeover switch 21a is on the upper side, and an operation amount 106a before one control period is recorded in the storage part 22a. First, the image processing part 27 calculates an optical axis deviation amount 108a of the camera 11 based upon the captured image 107 acquired before the camera 11 performs one operation (a computation method will be described later). The optical axis deviation amount 108a and the operation amount 106a before one control period stored in the storage part 22a are added by the adder 23a, which is defined as the deviation amount 108a which is a new target change angle command. Since a flow after the above-mentioned processing is the same as that of the case of the external command mode, description thereof will be omitted.

Next, a method for calculating the optical axis deviation amount of the camera will be described. The image processing part 27 has a storage part (not shown), and the storage part stores the captured image 107 before one imaging period. Then, the stored captured image 107 and a current image are converted into luminance information of 0-255 (gray scale), and a difference between respective pixel values of the two captured images 107 is obtained. A pixel, a difference value of which exceeds a predetermined value, is considered as a moving part 1 (white), and when a pixel, a difference value of which is lower than a predetermined value is set as 0 (black) (binarization processing). The aforementioned method is referred to as a frame difference method which is one type of background difference method.

FIG. 6 illustrates a result of the binarization processing with respect to the captured image 107. Further, a scanning direction of the motor 13a is a direction in which a right side is defined as positive on right and left sides of a paper surface (hereinafter, referred to as an x-axis direction), and a scanning direction of the motor 13b is a direction in which an upper side is defined as positive on upper and lower sides of the paper surface (hereinafter, referred to as a y-axis direction). When an area of a moving pixel group has a predetermined size or shape in the captured image 107, the pixel group is determined to be the flying object. At this time, a gravity center position of the moving pixel group is defined as a center position Q of the flying object in the captured image 107, and a difference (x-axis direction is qₐ, y-axis direction is q_{b}) between coordinate values of an image center O and the center position Q of the flying object is defined as the optical axis deviation amount of the camera 11. The next movable mirror rotation operation is performed based upon the optical axis deviation amount of each axis.

The moving object imaging device 1 according to the embodiment defines the flying object freely flying around space as an object for imaging (tracking). The scanning direction of the larger movable mirror 12b far from the camera is defined as the gravity direction. What is mentioned above is arranged in consideration of response characteristics of a deflection mechanism formed with the movable mirror and the motor, and moving characteristics of the flying object, thereby implementing tracking performance of the moving object imaging device to the maximum.

First, the response characteristics of the deflection mechanism formed with the movable mirror and the motor will be described. In the embodiment, since the movable mirror is stationary while the camera 11 is capturing an image, the motor repeatedly rotates and stops for each imaging period. The aforementioned operation is regarded as a reciprocating operation between two points, and power consumption of the motor is estimated, and a relationship between the moving distance and the power consumption is contemplated. Further, the motor has a plurality of mechanism resonance modes, however, the motor herein is treated as a rigid object to improve visibility, and a current flowing through the motor is also treated as a single sine wave. When a coil part of the motor is set as an inductor Lc and a resistor Rc, an equation of motion when a rotor rotates at a frequency f and a vibration amplitude θ₀, an equation 1 is represented as follows:

$$\begin{matrix}[ Math . 1 ] & \\ \{ \begin{matrix}θ = {θ}_{0} sin ( 2 π f t ) \\ V = {L}_{c} \frac{dI}{dt} + {R}_{c} I + {k}_{t} \frac{d θ}{dt} \\ J \frac{{d}^{2} θ}{{dt}^{2}} = {k}_{t} I\end{matrix} & ( Equation 1 )\end{matrix}$$

Here, θ: rotational angle, t: time, V: voltage, I: current, kt: torque constant of motor, J: moment of inertia of whole movable elements. At this time, power Pₑ consumed by the coil per unit time T is represented by the following equation:

$$\begin{matrix}[ Math . 2 ] & \\ {P}_{e} = \frac{1}{T} {\int }_{0}^{T} V ( t ) I ( t ) dt & ( Equation 2 )\end{matrix}$$

According to the equations 1 and 2, Pₑ is represented as follows:

$$\begin{matrix}[ Math . 3 ] & \\ {P}_{e} = \frac{1}{2} {θ}_{0}^{2} {{R}_{c} ( \frac{J}{{k}_{t}} )}^{2} {( 2 π f )}^{4} & ( Equation 3 )\end{matrix}$$

According to the equation 3, the power consumption is proportional to the fourth power of the frequency f, and is proportional to the square of the moment of inertia of the whole movable elements and the rotational angle.

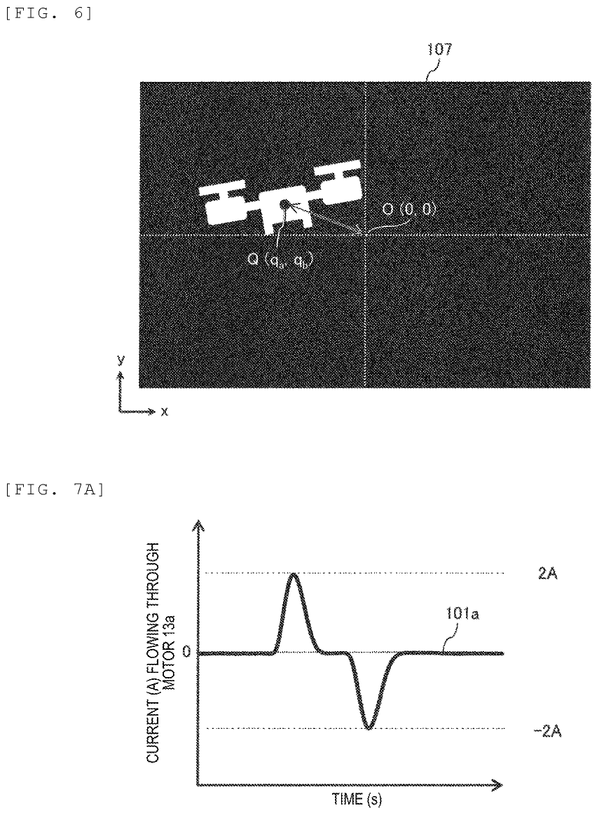

FIGS. 7A and 7B illustrates driving currents 101a and 101b flowing through the respective motors when the motors 13a and 13b, on which the movable mirrors 12a and 12b having different sizes are mounted, are moved only by the same rotational angle, and a vertical axis represents a magnitude of the current and a horizontal axis represents time. Further, since the motor shape is the same and the resistance Rc is the same, the power consumption is proportional to the square of the current. As apparent from comparison between two drawings, the motor 13b on which the movable mirror 12b having the large moment of inertia is mounted requires a larger current than the motor 13a on which the movable mirror 12a having the small moment of inertia is mounted. Therefore, an amount of heat generation caused by copper loss of a coil increases.

Since the power consumption is proportional to the square of the current as described above, when a peak value of the current of the motor 13a is 2A, and a peak value of the current of the motor 13b is 3A, the power consumption of the motor 13b becomes 2.25 times (=32/22 times)at the maximum in comparison with the power consumption of the motor 13a.

A heat removal amount caused by natural heat radiation of the motor is determined from a structure, and a general motor has rated power consumption to be prevented from becoming more than an allowable temperature as a specification. When the motor structure and the rotational angle cannot be changed, an only way to lower the power consumption is to lower the frequency f. That is, the deflection mechanism on which the large movable mirror is mounted is inferior in response performance in comparison with the deflection mechanism on which the small movable mirror is mounted. Further, lowering the frequency f means extending the imaging period, and when tracking of the moving object is performed by the captured image 107 as in the embodiment, the tracking performance of the motor in the scanning direction deteriorates.

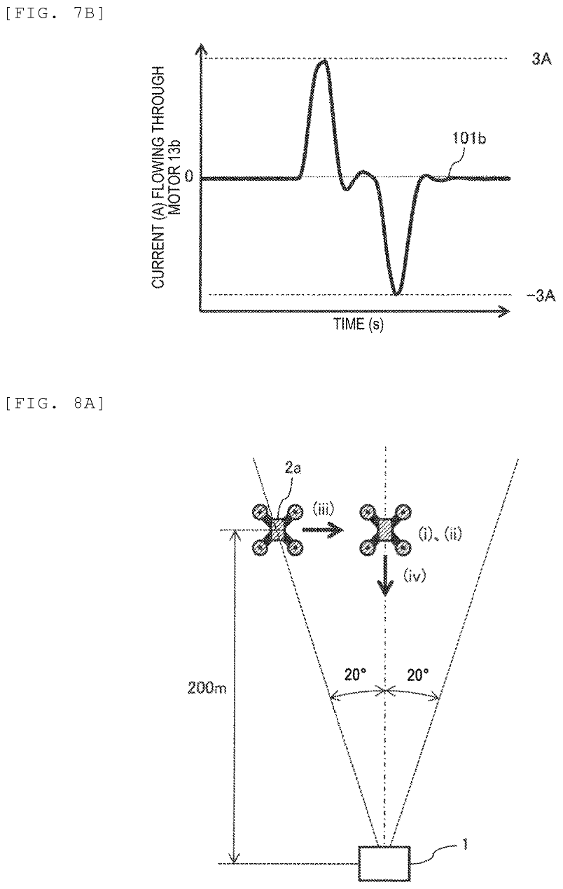

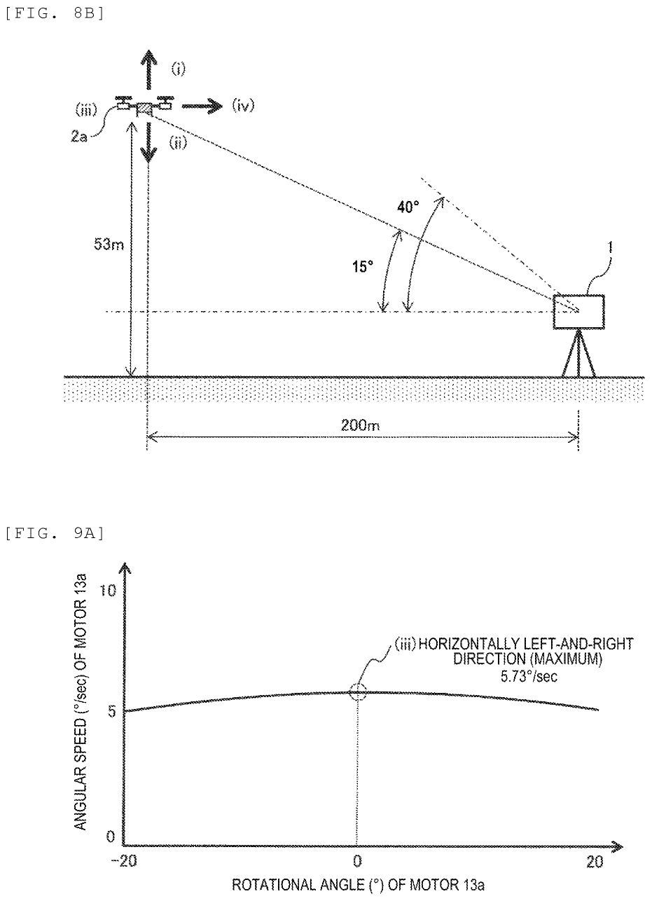

Next, movement characteristics of the moving object 2a are considered. FIG. 8A illustrates a drawing when looking down a positional relationship between the moving object imaging device 1 and the flying object 2a from the sky above. FIG. 8B illustrates a drawing when both the moving object imaging device 1 and the flying object 2a are viewed from a certain point on the ground from a lateral direction.

The multi-copter which is an object to be imaged in the embodiment has a high moving speed in the horizontal direction, but has a low moving speed in the gravity direction. For example, while a catalog specification of Phantom 4 manufactured by DJI has a maximum horizontal speed of 20 m/s (72 km/h), an ascending speed is 6 m/s and a descending speed is 4 m/s.

Here, a scanning range of the movable mirror 12b scanning in the gravity direction is set from 0° (horizontal) to an elevation angle of 40°, and a scanning range of the movable mirror 12a scanning in the horizontal direction is set to 20° to the left and right. As shown in FIG. 8B, when the flying object 2a exists at a point 200 m away from the moving object imaging device 1 and exits above the altitude of 53 m (the rotational angle of the motor 13b is) 15°, movements in respective directions of (i) ascent, (ii) descent, (iii) horizontal to left and right, and (iv) approach of the flying object 2a can be tracked by controlling the rotational angle of each motor as follows:
(i) ascent (the rotational angle of the motor 13a is fixed at 0°, and tracking is performed by scanning of the motor 13b).
(ii) Descent (same as that of (i))
(iii) Horizontal directions to left and right (the rotational angle of the motor 13b is fixed at 15°, and tracking is performed by scanning of the motor 13a).
(iv) Approach direction (same as that of (i))

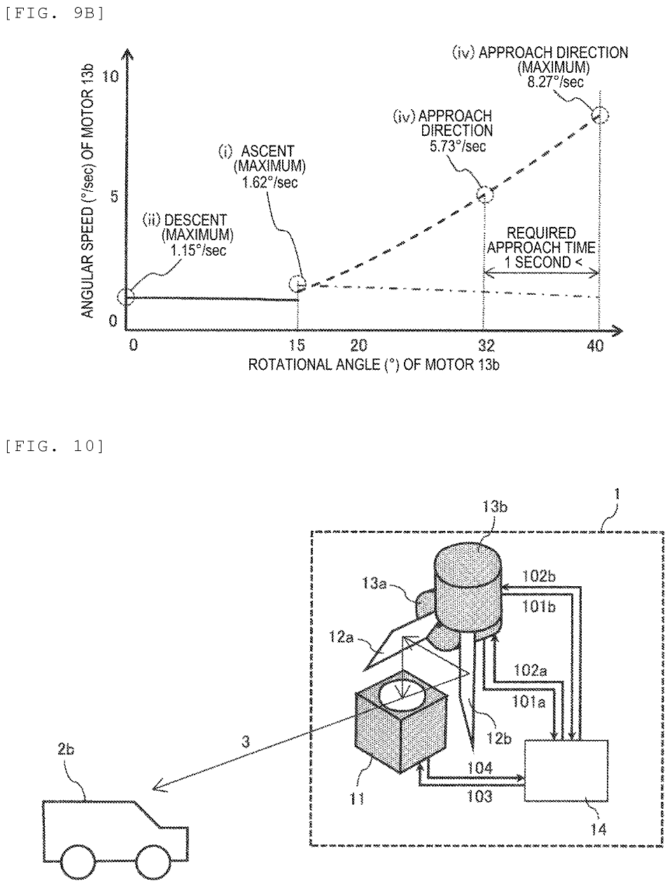

Further, the maximum angular speed of each motor and the rotational angle for each imaging period when moving from a position of the flying object 2a in FIG. 8B to the respective directions of (i) to (iv) at the maximum speed are illustrated in FIGS. 9A and 9B.

As shown in FIG. 9A, (i) the maximum angular speed of the motor 13a at the time of the ascent is 1.62°/sec, and (ii) the maximum angular speed at the time of the descent is 1.15°/sec. Further, as shown in FIG. 9B, (iii) the maximum angular speed of the motor 13b at the time of the movement in the horizontal direction to left and right is 5.73°/sec. As can be seen from these drawings, in the movements of (i) to (iii), the maximum angular speed is approximately the same even though a distance and an altitude are different. Further, the maximum angular speed of the motor 13a in (iii) is about 3.3 to 5.7 times larger than the maximum angular speed of the motor 13b in (i) or (ii).

Meanwhile, as shown in FIG. 9B, (iv) the angular speed of the motor 13b at the time of moving in an approach direction increases as a distance from the flying object 2a becomes shorter, particularly, when a distance from the moving object imaging device 1 is 80 to 65 m, (iv) the angular speed of the motor 13b at the time of moving in an approach direction becomes larger than the maximum angular speed 5.73°/sec of (iii).

When the distance to the flying object 2a is less than 65 m, a center of the captured image 107 acquired from a restriction of a motor movable area can not be grasped, thereby becoming difficult to perform the tracking. As described above, when a flying object freely flying around space is set as an object to be imaged (tracking), it can be seen that a severe scanning direction in the tracking performance required for the moving object imaging device is the left-and-right direction with respect to the acquired screen, except in a case where the flying object is within 85 meters of the moving object imaging device and approaches further the moving object imaging device.

Further, when the flying object 2a, the maximum speed in the horizontal direction of which is 20 m/sec (72 km/h) is used, the time required for passing the distance between 85 m and 65 m in the approach direction operation (iv) is only one second, whereby it is a significantly extreme example as a situation in which the flying object 2a freely flying around space is tracked. Further, when an importance level of tracking the flying object approaching in the approach direction is high, it is desirable to cope with the situation by adopting the same configuration as that of a second embodiment which will be described later.

Based upon the above-mentioned considerations, in the moving object imaging device 1 of the embodiment that images (tracks) the flying object 2 freely flying around space, the scanning direction of the large movable mirror far from the camera 11 is set to coincide with the gravity direction where the maximum angular speed required for the movable mirror is small, thereby suppressing the power consumption required for driving the movable mirror. Therefore, the larger movable mirror can be used in comparison with a case where the scanning direction of the movable mirror far from the camera 11 is defined as the left-and-right direction of the captured image 107, thereby making it possible to maintain both improvement of imaging quality and tracking performance.

Further, in the moving object imaging device 1 of the embodiment, as shown in FIG. 3, the reflection surface of the movable mirror 12b, the scanning direction of which is the gravity direction, faces the ground surface. In the moving object imaging device 1 in which movable mirrors 12a, 12b, and the like are stored in a casing as shown in FIG. 3, an opening part of the casing, that is, a direction in which the flying object 2a is observed becomes a left direction of a paper surface. Accordingly, for example, even when the sun is present at a point B diagonally above the left of the opening part, the reflection surface of the movable mirror 12b faces an opposite side of the sun, thereby having an effect of reducing inflow of reflected light caused by the movable mirror 12b in the casing. Further, the movable mirror 12a faces the point B, however, since the mirror 12a exists at a position deeper than the mirror 12b, there exist few cases in which the sunlight directly hits the reflection surface, and a reflection area is smaller than the mirror 12b, the movable mirror 12a has a slighter influence in comparison with an influence of the sunlight caused by the movable mirror 12b.

In the embodiment, as shown in FIG. 6, a frame difference method is used for detecting the flying object 2a.

For example, another method such as a code book method for learning a plurality of background models, and the like may be used. Further, it may be considered to improve the image quality accompanied by an increase in the number of pixels by setting a focal length of the lens the same. In this case, since an angle of view is widened, and the reflection area of the movable mirror is enlarged, the embodiment still remains effective. In the embodiment, a multi-copter is assumed as the flying object, however, since it is extremely difficult to freely fly in a vertical direction in the case of a winged aircraft which is one example of another flying object, a result in consideration of the winged aircraft is the same as a result in consideration of the multi-copter.

According to the configuration of the embodiment described above, even though a large movable mirror is used to improve the image quality, since the heat generation amount of the motor can be suppressed, it is possible not only to improve the image quality, but also to maintain the tracking performance.

### Second Embodiment

Next, the moving object imaging device 1 of the second embodiment will be described with reference to FIGS. 10 to 12. The moving object imaging device 1 of the embodiment uses a traveling object 2b such as a vehicle approaching while traveling on a road as a tracking object. For example, the moving object imaging device 1 may be a device for automatically reading an automobile number (N system), and the like. Further, redundant descriptions of common points between the first and second embodiments will be omitted.

FIG. 10 is a block diagram including the moving object imaging device 1 of the embodiment and the traveling object 2b viewed from a side-surface side. In the first embodiment, the scanning direction of the movable mirror 12b positioned farthest from the camera 11 is defined as the gravity direction. Meanwhile, in this embodiment, the scanning direction of the movable mirror 12b positioned farthest from the camera 11 is defined as a screen horizontal direction.

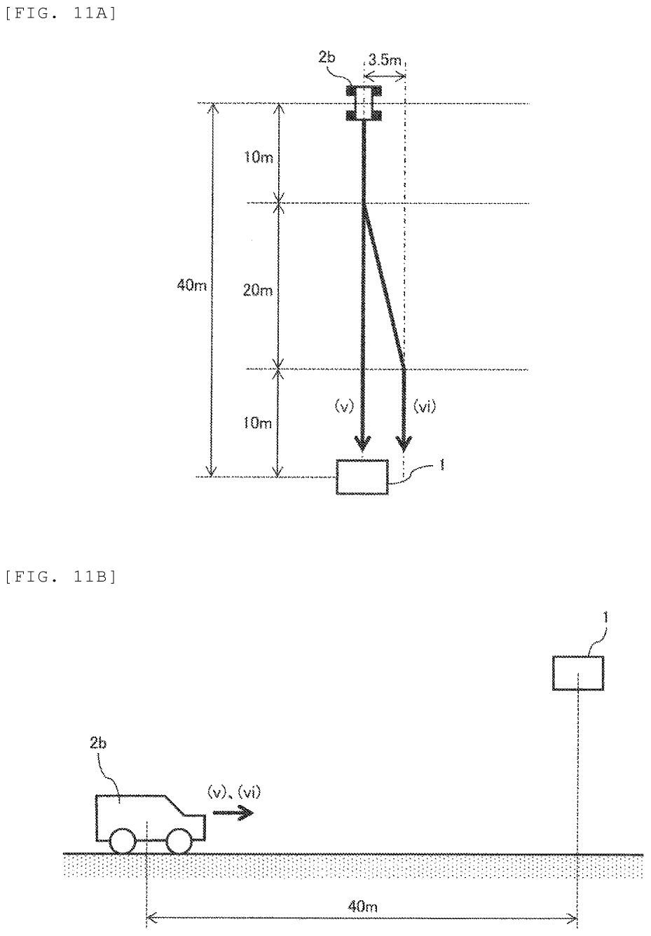

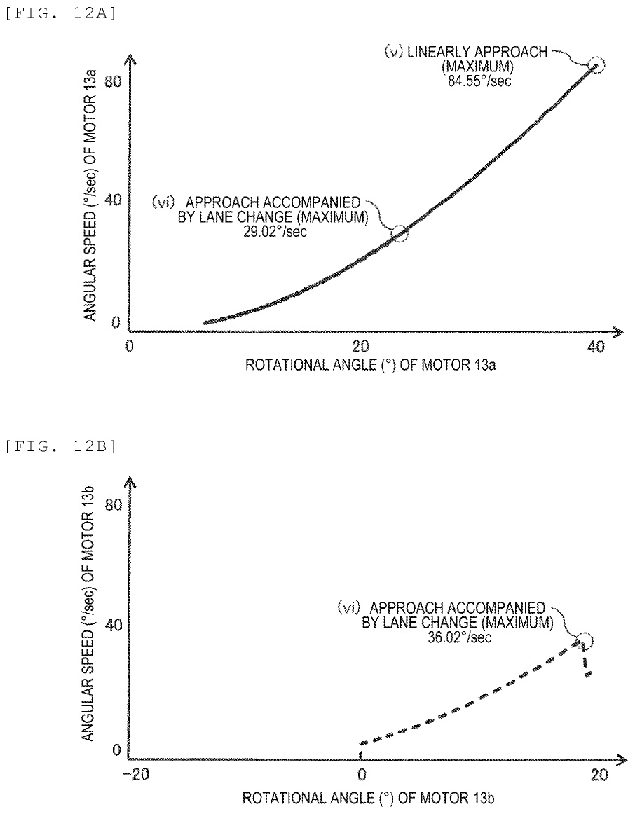

Since the imaging operation and the movement of each part, and the like are the same as those of the first embodiment, here, only moving characteristics of the traveling object 2b are paid attention to. FIG. 11A is a diagram illustrating a positional relationship between the moving object imaging device 1 and the traveling object 2b from the sky above, and FIG. 11B is a diagram when both the moving object imaging device 1 and the traveling object 2b are viewed form a certain point on the ground from a lateral direction.

In the traveling object 2b linearly approaching the moving object imaging device 1, there exists a case in which a traveling speed in an approach direction exceeds 100 km/h, and even at the time of a lane change, since a lane width is only about 3.5 m, there exists a traveling characteristic in that a traveling speed in the left-and-right direction is slow.

Here, a scanning range of the movable mirror 12a scanning in the approach direction is set to 0° (horizontal) to an elevation angle of 40°, and an investigation range of the movable mirror 12b scanning in the horizontal direction is set to 20°.

As shown in FIG. 11P, a movement (v) in which the traveling object 2b approaches the moving object imaging device 1 from a point away from 40 m; and a movement (vi) in which the traveling object 2b approaches closer than the point away from 40 m, starts operation to change to a lane deviated in a 3.5 m horizontal direction from a point away from 30 m, and completes the lane change at a point away from 10 m and passes under the moving object imaging device 1 can be tracked by controlling the rotational angle of each motor as follows:
(v) The rotational angle of the motor 13b is fixed at 0°, and tracking is performed by scanning of the motor 13a
(vi) Tracking is performed by appropriate scanning of the motors 13a and 13b

Further, the maximum angular speed of each motor and the rotational angle for each imaging period when the movement (v) or (vi) is performed from the position of the traveling object 2b in FIG. 11A are illustrated in FIGS. 12A and 12B. Here, an installation position of the moving object imaging device 1 is set to 4 m above the ground surface, and a traveling object speed is set to 13.9 m/sec (50 km/h). Additionally, when the traveling object 2b approaches the moving object imaging device 1 at 4.8 min the movement of (v) and approaches the moving object imaging device 1 at 9.74 m in the movement of (vi), the traveling object 2b becomes out of the imaging range.

According to the comparison between FIGS. 12A and 12B, it is found out that the maximum angular speed occurs when the traveling object is closest (84.55°/sec)in the motor 13a of a direction in which the traveling object approaches, on the other hand, the maximum angular speed of the motor 13b is relatively small.

Therefore, in the moving object imaging device 1, the generated power consumption is suppressed by matching the scanning direction of the large movable mirror far from the camera 11 with the left-and-right direction of the screen in which the maximum angular speed required for the movable mirror is small.

Further, in the embodiment, the tracking object is described as the traveling object 2b. However, the object to which the embodiment is applied is not limited to the traveling object, and the flying object 2a approaching toward the moving object imaging device 1 may be the tracking object.

### Third Embodiment

In the second and third embodiments, the movable mirror 12b can be made small by narrowing a distance between the two motors, however, since the movable mirror, the motor, and the like physically interferes with each other, a movable area of each movable mirror is narrowed. This improvement method therefor will be described in the third embodiment.

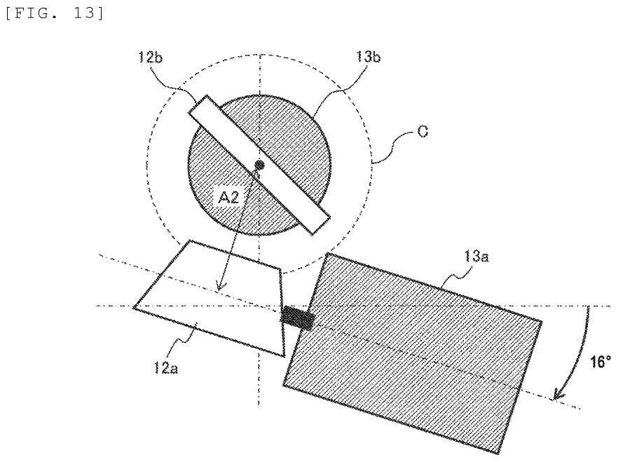

FIG. 13 is a cross-sectional diagram of the moving object imaging device 1 when the direction of the movable mirror 12a is viewed from the camera mounting position in the third embodiment. The moving object imaging device 1 of the embodiment is characterized in that the rotary shaft of the motor 13a is arranged to be rotated clockwise with respect to the rotary shaft of the motor 13b in comparison with the cross sectional view of FIG. 3.

In FIG. 3 of the first embodiment, the distance A1 between the motor 13a and the rotary shaft of the motor 13b is set to 42.5 mm, and the movable range of each movable mirror is set to ±20°. Further, as an area that is provided so that the movable mirror 12b does not interfere with the motor 13a, the circle C is set around the rotary shaft of the movable mirror 12b.

On the other hand, also in the embodiment, the motor 13a is installed while avoiding the circle C that is provided in order that the movable mirror 12b does not interfere with the motor 13a, and it is possible to set a distance A2 (41.0 mm) of the rotary shaft between the motor 13a and the motor 13b smaller than the distance A1 (42.5 mm) in FIG. 3 by inclining a mounting angle of the motor 13a by 16°. As a result, a size of the movable mirror 12b required for securing the same imaging range can be reduced.

Since the moment of inertia of the movable mirror 12b can be reduced by miniaturizing the movable mirror 12b, the power consumption required for driving the movable mirror 12b can be reduced, and further, the movable mirror 12b can be driven at a higher speed.

Further, in the moving object imaging device 1 according to the embodiment, the captured image 107 obtained at the mounting position of the camera 11 is inclined by a mounting angle of the rotary shaft of the movable mirror 12a. Therefore, by inclining the camera with respect to the optical axis and mounting the camera, the horizontal and vertical directions of the acquired captured image 107 and the scanning direction coincide with each other, and the operation of the present device can be intuitively performed. Further, even though the camera 11 is horizontally mounted, what is described just above can be realized by adding numerical calculation processing such as coordinate conversion to the acquired captured image 107, however, since the computation processing is required, an update period of image information to be sent to the display device deteriorates.

The present invention is not limited to the embodiments described above, and includes various modifications. For example, the above-mentioned embodiments are described in detail so as to describe the present invention in an easy-to-understand manner, and are not necessarily limited to those including all of the configurations described herein.

### REFERENCE SIGNS LIST

1: moving object imaging device

2a: flying object

2b: traveling object

3: optical axis

11: camera

12a, 12b: movable mirror

121a, 121b: reflection mirror part

122a, 122b: mounting part

13a, 13b: motor

14: controller

20: command input device

21a, 21b: switch

22a, 22b: storage part

23a, 23b, 24a, 24b: adder

25a, 25b: compensator

26a, 26b: amplifier

27: image processing part

101a, 101b: driving current

102a, 102b: detection angle

103: imaging trigger signal

104: imaging end signal

105a, 105b: target angle command

106a, 106b: operation amount

107: captured image

108a, 108b: deviation amount

1. A moving object imaging device for tracking and imaging a moving object crossing an approximately horizontal direction, comprising:
a camera configured to capture an image of the moving object sequentially reflected by a plurality of movable mirrors;
a mirror movable in a gravity direction configured to define a gravity direction of the captured image of the camera as a scanning direction;
a first motor configured to change an angle of the mirror movable in the gravity direction;
a mirror movable in a left-and-right direction configured to define a left-and-right direction of the captured image of the camera as a scanning direction;
a second motor configured to change an angle of the mirror movable in the left-and-right direction; and
a controller configured to control the camera, the first motor, and the second motor,
the camera capturing the image of the moving object that is sequentially reflected by the mirror movable in the gravity direction and the mirror movable in the left-and-right direction.

2. The moving object imaging device according to claim 1, wherein
moment of inertia of the mirror movable in the gravity direction is larger than moment of inertia of the mirror movable in the left-and-right direction.

3. A moving object imaging device for tracking and imaging a moving object approaching from an approximately horizontal direction, comprising:
a camera configured to capture an image of the moving object sequentially reflected by a plurality of movable mirrors;
a mirror movable in a gravity direction configured to define a gravity direction of the captured image of the camera as a scanning direction;
a first motor configured to change an angle of the mirror movable in the gravity direction;
a mirror movable in a left-and-right direction configured to define a left-and-right direction of the captured image of the camera as a scanning direction;
a second motor configured to change an angle of the mirror movable in the left-and-right direction; and
a controller configured to control the camera, the first motor, and the second motor,
the camera capturing the image of the moving object that is sequentially reflected by the mirror movable in the gravity direction and the mirror movable in the left-and-right direction.

4. The moving object imaging device according to claim 3, wherein
moment of inertia of the mirror movable in the left-and-right direction is larger than moment of inertia of the mirror movable in the gravity direction.

5. The moving object imaging device according to claim 1, wherein
a reflection surface of the mirror movable in the gravity direction is mounted to face a ground surface.

6. The moving object imaging device according to claim 1, wherein
an image acquired at a mounting position of the camera is inclined.

7. The moving object imaging device according claim 6, wherein
the camera is obliquely mounted with respect to a ground surface.

8. A moving object imaging method of tracking and capturing an image of a moving object crossing an approximately horizontal direction,
the image of the moving object being captured by a camera, wherein the image of the moving object is sequentially reflected by
a mirror movable in a gravity direction configured to define a gravity direction of the captured image of the camera as a scanning direction, and to have large moment of inertia; and
a mirror movable in a left-and-right direction configured to define a left-and-right direction of the captured image of the camera as a scanning direction, and to have small moment of inertia.

9. A moving object imaging method of tracking and capturing an image of a moving object approaching from an approximately horizontal direction,
the image of the moving object being captured by a camera, wherein the image of the moving object is sequentially reflected by
a mirror movable in a left-and-right direction configured to define a left-and-right direction of the captured image of the camera as a scanning direction, and to have large moment of inertia; and
a mirror movable in a gravity direction configured to define a gravity direction of the captured image of the camera as a scanning direction, and to have small moment of inertia.
